(19) United States
(12) Patent Application Publication
(10) Pub. No.: US 2025/0307875 A1
(43) Pub. Date: Oct. 2, 2025

(54) INFORMATION PROCESSING APPARATUS AND INFORMATION PROCESSING METHOD

(71) Applicant: NEC Corporation, Tokyo (JP)

(72) Inventors: Rui KONDO, Tokyo (JP); Yasuhiko YOSHIDA, Tokyo (JP); Shinnosuke NISHIMOTO, Tokyo (JP)

(73) Assignee: NEC Corporation, Tokyo (JP)

(21) Appl. No.: 19/063,421

(22) Filed: Feb. 26, 2025

(30) Foreign Application Priority Data
Mar. 28, 2024 (JP) 2024-053505

(51) Int. Cl. G06Q 30/0251; G06F 21/62

(52) U.S. Cl. CPC G06Q 30/0269; G06F 21/6245

(57) ABSTRACT

An information processing apparatus includes an information acquisition unit that acquires avatar information and acquires content provider information. The information processing apparatus includes an estimation unit that estimates a degree of relevance between the avatar and the content provider on the basis of the avatar information and the content provider information. The information processing apparatus includes a consent reception unit that receives, from a user corresponding to the avatar, a consent to disclose personal information of the user to the content provider with the degree of relevance with the avatar of not less than a threshold value. The information processing apparatus includes a disclosure unit that discloses the personal information of the user to the content provider in a case where the consent reception unit receives the consent.

### INCORPORATION BY REFERENCE

This application is based upon and claims the benefit of priority from Japanese patent application No. 2024-053505, filed on Mar. 28, 2024, the disclosure of which is incorporated herein in its entirety by reference.

### TECHNICAL FIELD

The present disclosure relates to an information processing apparatus, an information processing method, and a program.

### BACKGROUND ART

Content including advertisements and the like is provided in virtual spaces called the metaverse, for example, and constructed on the Internet by computers. Users join the virtual spaces in a form called avatars, for example. The avatars perform actions that mimic the users' actions.

Published Japanese Translation of PCT International Publication for Patent Application, No. 2010-535362 describes tracking an action of an avatar viewing a certain advertisement and providing information regarding the tracked action of the avatar to an advertiser. Furthermore, Published Japanese Translation of PCT International Publication for Patent Application, No. 2010-535362 describes performing data mining and profiling to determine predefined likes and dislikes, a geographical position, a language, and other attribute information of a user corresponding to each avatar.

### SUMMARY

Advertisement business in virtual spaces has attracted attention with progress in techniques related to virtual spaces in recent years. Development of a technique for optimizing content of advertisements in a virtual space has been expected.

However, protection of personal data and privacy has become strict in recent years like in the General Data Protection Regulation (GDPR) established in Europe in 2016. Therefore, it is difficult to acquire attribute information of users.

An example object of the invention is to provide an information processing apparatus and a computer-implemented information processing method. Therefore, an object of the present disclosure is to provide a technique for suitably linking a content provider to a consumer in a virtual space.

In a first example aspect, an information processing apparatus includes:
an information acquisition unit that acquires avatar information indicating attributes of an avatar for each of a plurality of avatars and acquires content provider information indicating attributes of a content provider for each of a plurality of content providers;
an estimation unit that estimates a degree of relevance between the avatar and the content provider on the basis of the avatar information and the content provider information;
a consent reception unit that receives, from a user corresponding to the avatar, a consent to disclose personal information of the user to the content provider with the degree of relevance with the avatar of not less than a threshold value; and
a disclosure unit that discloses the personal information of the user to the content provider in a case where the consent reception unit receives the consent.

In a second example aspect, an information processing method includes, by a computer:
acquiring avatar information indicating attributes of an avatar for each of a plurality of avatars and acquiring content provider information indicating attributes of a content provider for each of a plurality of content providers;
estimating a degree of relevance between the avatar and the content provider on the basis of the avatar information and the content provider information;
receiving, from a user corresponding to the avatar, a consent to disclose personal information of the user to the content provider with the degree of relevance with the avatar of not less than a threshold value; and
disclosing the personal information of the user to the content provider in a case where the consent reception unit receives the consent.

In a third example aspect, a program causes a computer to function as:
an information acquisition unit that acquires avatar information indicating attributes of an avatar for each of a plurality of avatars and acquires content provider information indicating attributes of a content provider for each of a plurality of content providers;
an estimation unit that estimates a degree of relevance between the avatar and the content provider on the basis of the avatar information and the content provider information;
a consent reception unit that receives, from a user corresponding to the avatar, a consent to disclose personal information of the user to the content provider with the degree of relevance with the avatar of not less than a threshold value; and
a disclosure unit that discloses the personal information of the user to the content provider in a case where the consent reception unit receives the consent.

According to the present disclosure, it is possible to suitably link a content provider to a consumer in a virtual space.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a schematic block diagram illustrating an example of a configuration of an information processing apparatus according to the present disclosure;

FIG. 2 is a flowchart illustrating an example of an information processing method according to the present disclosure;

FIG. 3 is a schematic block diagram illustrating an example of a configuration of an information processing system according to the present disclosure;

FIG. 4 is a flowchart illustrating an example of an information processing method according to the present disclosure;

FIG. 5 is a schematic block diagram illustrating another example of the configuration of the information processing system according to the present disclosure; and

FIG. 6 is a block diagram illustrating an example of a configuration of a computer according to the present disclosure.

### EXAMPLE EMBODIMENTS

### First Example Embodiment

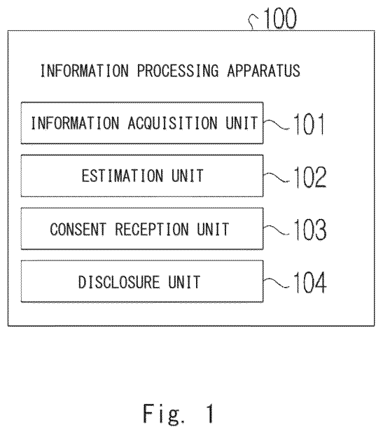

Hereinafter, an example of a configuration of an information processing apparatus 100 according to the present disclosure will be described with reference to FIG. 1. The information processing apparatus 100 includes an information acquisition unit 101, an estimation unit 102, a consent reception unit 103, and a disclosure unit 104.

The information acquisition unit 101 acquires avatar information indicating attributes of an avatar for each of a plurality of avatars and acquires content provider information indicating attributes of a content provider for each of a plurality of content providers.

The estimation unit 102 estimates a degree of relevance between the avatar and the content provider on the basis of the avatar information and the content provider information.

The consent reception unit 103 receives, from a user corresponding to the avatar, a consent to disclose personal information of the user to a content provider with a degree of relevance with the avatar not less than a threshold value.

In a case where the consent reception unit 103 receives the consent, the disclosure unit 104 discloses the personal information of the user to the content provider.

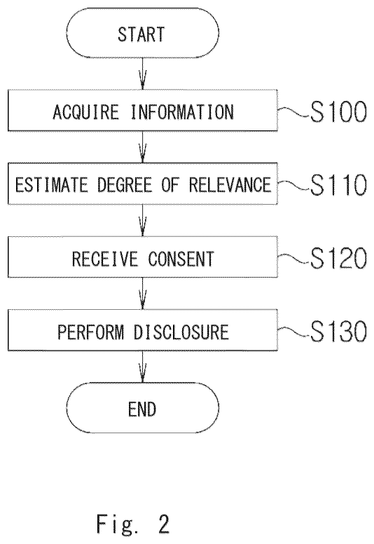

FIG. 2 is a flowchart illustrating an example of an information processing method according to the present disclosure. First, the information acquisition unit 101 acquires avatar information indicating attributes of an avatar for each of the plurality of avatars and acquires content provider information indicating attributes of a content provider for each of the plurality of content providers (S100). Next, the estimation unit 102 estimates a degree of relevance between the avatar and the content provider on the basis of the avatar information and the content provider information (S110). Then, the consent reception unit 103 receives, from a user corresponding to the avatar, a consent to disclose personal information of the user to a content provider with a degree of relevance with the avatar not less than a threshold value (S120). Next, in a case where the consent reception unit 103 receives the consent, the disclosure unit 104 discloses the personal information of the user to the content provider (S130) and ends the processing.

According to the above configuration, it is possible to suitably link a content provider to a user (consumer) in a virtual space.

### Second Example Embodiment

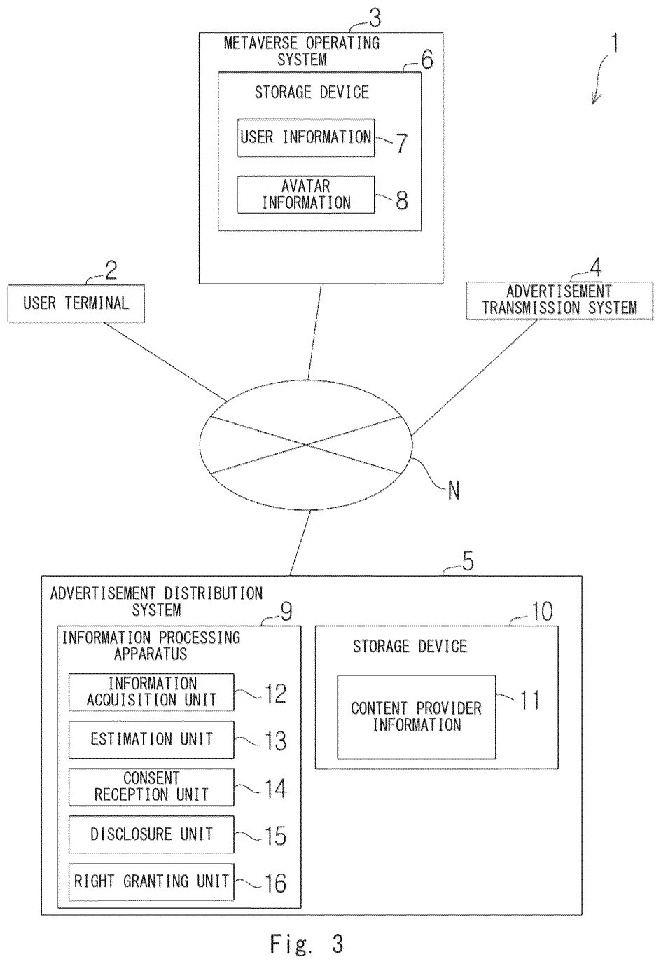

Next, an example of a configuration of an information processing system 1 according to the present disclosure will be described with reference to FIG. 3. The information processing system 1 suitably links a user corresponding to an avatar who has entered a virtual space to a content provider. Here, the virtual space is a virtual three-dimensional space constructed on a network such as the Internet by a computer. Specifically, the virtual space is generated by a computer and is expressed by three-dimensional computer graphics. Examples of the virtual space includes the metaverse. Also, the user joins the virtual space in a form called an avatar, for example. Also, the avatar performs actions that mimic actions of the user. The avatar is also generated by the computer and is expressed by three-dimensional computer graphics.

The following description will be given by exemplifying a metaverse as the virtual space. The information processing system 1 illustrated in FIG. 3 includes a user terminal 2, a metaverse operating system 3, an advertisement transmission system 4, and an advertisement distribution system 5. The user terminal 2, the metaverse operating system 3, the advertisement transmission system 4, and the advertisement distribution system 5 can communicate with each other via a network N. Note that the number of user terminals 2 included in the information processing system 1 may be equal to or greater than the number of avatars joining the metaverse.

Each user terminal 2 is a smartphone, a personal computer (PC), virtual reality (VR) goggles, or the like used by the user. The user terminal 2 may include a camera that images actions of the user. Furthermore, the user terminal 2 may include various sensors that measure an eye line, a heart rate, brain waves, and the like of the user.

The metaverse operating system 3 constructs a metaverse on the network N and operates the metaverse. The metaverse operating system 3 includes a storage device 6. The storage device 6 stores user information 7 and avatar information 8 for each of a plurality of users participating in the metaverse.

The user information 7 is information indicating attributes of a corresponding user. The attributes of the user typically include a name, an address, a telephone number, a gender, an age, an occupation, an annual income, financial assets, a family structure, preferences, tastes, and the like of the user. Therefore, the user information 7 can also be called personal information of the corresponding user. Hereinafter, the personal information of the user will also be simply referred to as user information. A plurality of disclosure levels defining disclosure ranges are set in the personal information of the user. In one exemplary case where the disclosure levels defining the disclosure range of personal information of the user are set in three levels, the disclosure range in a disclosure level 1 which is the narrowest disclosure range is constituted by preferences and tastes of the user. The disclosure range in a disclosure level 2 which is the second narrowest disclosure range is constituted by a gender of the user in addition to the preferences and the tastes. The disclosure range in a disclosure level 3 which is the widest disclosure range is constituted by all of a name, an address, a telephone number, a gender, an age, an occupation, an annual income, financial assets, a family structure, preferences, and tastes.

The avatar information 8 is information indicating attributes of the corresponding avatar. The avatar information 8 can also be called information that can be collected by other avatars participating in the metaverse. In other words, the avatar information 8 is also public information that can be obtained by any users participating in the metaverse. The attributes of the avatar typically include an appearance, content of utterances, and content of chatting of the avatar. The attributes of the avatar may include action information of the avatar in the metaverse. The action information of the avatar typically includes movement of a field of view of the avatar, movement of a line of sight of the avatar, a position of the avatar, a trajectory of movement of the avatar, a moving speed of the avatar, and the like. The field of view of the avatar is a range from the center of the face of the avatar to predetermined angles on the left and right sides. The line of sight of the avatar is a forward direction that the center of the face of the avatar faces. Thus, the amount of information in the avatar information 8 typically increases as activities of the corresponding avatar in the metaverse increase.

The advertisement transmission system 4 generates content including various advertisements that can be provided in the metaverse (hereinafter, simply referred to as “advertisement content”) and transmits (bids) the content to the advertisement distribution system 5.

The advertisement distribution system 5 provides appropriate advertisement content among various kinds of advertisement content transmitted (bid) from the advertisement transmission system 4 to the avatar in the metaverse. Specifically, the advertisement distribution system 5 includes an information processing apparatus 9 and a storage device 10 as illustrated in FIG. 3.

The storage device 10 stores content provider information 11. The content provider information 11 is information indicating attributes of the content provider. The attributes of the content provider are typically constituted by a type of product or service promoted by the advertisement content provided by the content provider, and a gender, an age, an occupation, an annual income, financial assets, a family structure, preferences, tastes, and the like of consumers targeted by the advertisement content.

The information processing apparatus 9 includes an information acquisition unit 12, an estimation unit 13, a consent reception unit 14, a disclosure unit 15, and a right granting unit 16.

The information acquisition unit 12 acquires avatar information of each of a plurality of avatars and acquires content provider information of each of a plurality of content providers. In other words, the information acquisition unit 12 acquires avatar information of each of the plurality of avatars from the metaverse operating system 3 via the network N. The information acquisition unit 12 acquires the content provider information 11 of each of the plurality of content providers from the storage device 10.

The estimation unit 13 estimates a degree of relevance between the avatar and the content provider on the basis of the avatar information and the content provider information. In other words, the estimation unit 13 selects any one piece of avatar information from among a plurality of pieces of avatar information, selects any one piece of content provider information from among a plurality of pieces of content provider information, and estimates a degree of relevance between the avatar corresponding to the selected avatar information and the content provider corresponding to the selected content provider information on the basis of the selected avatar information and the selected content provider information. The estimation unit 13 generates all combinations of one of the plurality of pieces of avatar information and one of the plurality of pieces of content provider information and estimates a degree of relevance for each of the generated combinations. Here, each degree of relevance between the avatar and the content provider is considered to have a correlation with a degree of relevance between the user corresponding to the avatar and the content provider corresponding to the content provider information. In this manner, since the estimation unit 13 can estimate the degree of relevance between the user and the content provider using the avatar information that can be obtained by any user participating in the metaverse without referring to the personal information of the user, it is possible to estimate the degree of relevance between the user and the content provider to some extent even under a condition that it is difficult to acquire the personal information of the user.

Here, although the following first estimation method and second estimation method are exemplified as an estimation method by which the estimation unit 13 estimates the degree of relevance between the avatar and the content provider on the basis of the avatar information and the content provider information, the estimation method is not limited thereto.

In the first estimation method, the estimation unit 13 estimates user information of the user corresponding to the avatar information on the basis of the avatar information first. For example, there is a trend that an appearance of the avatar reflects an age, a gender, and a taste of the user. Therefore, it is possible to state that the estimation unit 13 can estimate the age, the gender, and the taste of the user on the basis of the appearance of the avatar. Furthermore, there is a trend that content of utterances and content of chatting of the avatar reflect an age, a gender, a family structure, preferences, and tastes of the user, for example. Therefore, it is possible to state that the estimation unit 13 can estimate the age, the gender, the family structure, the preferences, and the tastes of the user on the basis of the content of utterances and the content of chatting of the avatar.

The estimation unit 13 can also use an estimation model generated by machine learning when the estimation unit 13 estimates user information of the user corresponding to the avatar information on the basis of the avatar information. In other words, the estimation unit 13 can generate an estimation model by optimizing a neural network such that once the avatar information is input, the user information is output, using the plurality of pieces of avatar information and the plurality of pieces of user information associated with each other in a one-to-one relationship as training data. Then, the estimation unit 13 can estimate the user information by inputting the avatar information to the generated estimation model. Note that since the avatar information and the user information are stored in the storage device 6 in the metaverse operating system 3, a mode in which the metaverse operating system 3 instead of the estimation unit 13 generates the above estimation model and the generated estimation model is provided to the advertisement distribution system 5 is also conceivable.

Next, the estimation unit 13 estimates a degree of relevance between the avatar and the content provider on the basis of the estimated user information and the content provider information. As described above, the user information is constituted by a gender, an age, an occupation, an annual income, financial assets, a family structure, preferences, tastes, and the like of the user. Also, the content provider information is constituted by a gender, an age, an occupation, an annual income, financial assets, a family structure, preferences, tastes, and the like of consumers targeted by the advertisement content. Therefore, the estimation unit 13 compares a plurality of attributes constituting the user information with a plurality of attributes constituting the content provider information and calculates a degree of matching for each of the plurality of attributes. Then, the estimation unit 13 estimates a value obtained by adding the degree of matching calculated for each of the plurality of attributes as a degree of relevance between the corresponding avatar and the content provider. Here, the estimation unit 13 may obtain the degree of relevance by multiplying the degree of matching for each of the plurality of attributes by a predetermined weighting coefficient and adding the degree of matching for each of the plurality of attributes.

In the second estimation method, the estimation unit 13 estimates the degree of interest of the avatar in the content provider by inputting the avatar information and the content provider information to an interest degree estimation model after learning first. Specifically, the estimation unit 13 generates the interest degree estimation model by optimizing a neural network such that once the avatar information and the content provider information are input, the degree of interest when the avatar corresponding to the avatar information views content of the content provider information is output. At this time, training data is constituted by the avatar information, the content provider information, and the degree of interest. The degree of interest can be generated from action information constituting the avatar information. In other words, the degree of interest may be typically calculated in accordance with a period of time during which a line of sight of the corresponding avatar is directed to certain content. In this case, the degree of interest corresponding to the avatar information and the content provider information may be obtained by multiplying the above period of time by a predetermined coefficient. In other words, the degree of interest may be typically calculated in accordance with a period of time during which the corresponding avatar stays in an advertisement space where specific content is provided. In this case, the degree of interest corresponding to the avatar information and the content provider information may be obtained by multiplying the above period of time by a predetermined coefficient. In this manner, the estimation unit 13 can generate the above training data by obtaining the degree of interest corresponding to the avatar information and the content provider information.

Next, the estimation unit 13 estimates the degree of relevance between the avatar and the content provider on the basis of the estimated degree of interest. The estimation unit 13 may typically estimate the degree of relevance by multiplying the estimated degree of interest by a predetermined coefficient.

The consent reception unit 14 receives a consent to disclose personal information of the user corresponding to the avatar to the content provider with the degree of relevance with the avatar of not less than a threshold value from the user via the user terminal 2. Specifically, the consent reception unit 14 presents a plurality of content providers with degrees of relevance with a certain avatar of not less than the threshold value to the user via the user terminal 2. The user inputs a consent to disclose personal information to the user terminal 2 for each of the plurality of content providers. Then, the user terminal 2 transmits a consent result to the consent reception unit 14.

In the present example embodiment, a plurality of disclosure levels for defining disclosure ranges are set in the personal information of the user. Therefore, the consent reception unit 14 may input a consent to disclose the personal information to the user terminal 2 for each of the disclosure levels. The user terminal 2 transmits a consent result for each of the disclosure levels to the consent reception unit 14.

The consent reception unit 14 may perform processing of encouraging the user to give a similar consent for disclosure to other content providers similar to the content provider in accordance with the disclosure level approved by the user.

In a case where the consent reception unit 14 receives the consent, the disclosure unit 15 discloses the personal information of the user to the content provider. In this manner, the content provider can acquire the personal information of the user with high relevance with the content provider. In a case where an action of giving a consent has been performed for each disclosure level, the disclosure unit 15 discloses the personal information of the user to the content provider within the disclosure range in accordance with the approved disclosure level.

In a case where the consent reception unit 14 receives a consent, the right granting unit 16 grants a right of the user to receive a reward from the content provider to the user. In this manner, it is possible to promote the user to disclose own personal information to the content provider. Note that in a case where the consent reception unit 14 receives a consent, the right granting unit 16 may grant the right of the user to receive a reward from the content provider to the user in accordance with the disclosure level of consent, which has been received. For example, the right granting unit 16 may grant a right of the user to receive more rewards from the content provider in a case where a consent for disclosure at a disclosure level of a wider disclosure range is obtained than in a case where a consent for disclosure only at a disclosure level of a narrower disclosure range is obtained.

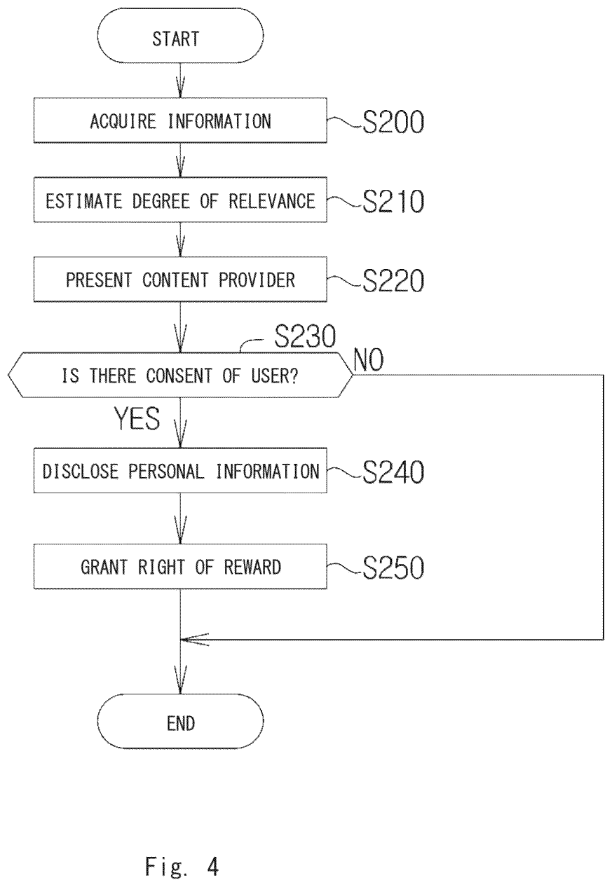

FIG. 4 is a flowchart illustrating an example of an information processing method according to the present disclosure. As illustrated in FIG. 4, the information acquisition unit 12 acquires avatar information indicating attributes of an avatar for each of a plurality of avatars and acquires content provider information indicating attributes of a content provider for each of a plurality of content providers (S200). Next, the estimation unit 13 estimates a degree of relevance between the avatar and the content provider on the basis of the avatar information and the content provider information (S210). Then, the consent reception unit 14 presents, to the user, a content provider with a degree of relevance with the avatar of not less than a threshold value, that is, a content provider with high relevance (S220). Next, the consent reception unit 14 receives a consent to disclose personal information to the content provider from the user (S230). In a case where the consent reception unit 14 receives the consent from the user in Step S230 (S230: YES), the disclosure unit 15 discloses the personal information of the user to the content provider (S240). Then, the right granting unit 16 grants a right of the user to receive a reward from the content provider to the user (S250) and ends the processing. In a case where the consent reception unit 14 does not receive the consent from the user in Step S230 (S230: NO), the consent reception unit 14 similarly ends the processing.

Although the second example embodiment has been described hitherto, the above second example embodiment has the following features.

The information processing apparatus 9 includes the information acquisition unit 12 that acquires avatar information indicating attributes of an avatar for each of a plurality of avatars and acquires content provider information indicating attributes of a content provider for each of a plurality of content providers. The information processing apparatus 9 includes the estimation unit 13 that estimates a degree of relevance between the avatar and the content provider on the basis of the avatar information and the content provider information. The information processing apparatus 9 includes the consent reception unit 14 that receives, from a user corresponding to the avatar, a consent to disclose personal information of the user to the content provider with the degree of relevance with the avatar of not less than a threshold value. The information processing apparatus 9 includes a disclosure unit 15 that discloses the personal information of the user to the content provider in a case where the consent reception unit 14 receives the consent. According to the above configuration, it is possible to suitably link a content provider to a consumer in a virtual space.

The estimating of the degree of relevance between the avatar and the content provider on the basis of the avatar information and the content provider information is estimating user information indicating attributes of a user corresponding to the avatar information on the basis of the avatar information and estimating the degree of relevance between the avatar and the content provider on the basis of the user information and the content provider information. According to the above configuration, it is possible to estimate the degree of relevance between the avatar and the content provider with high accuracy.

Also, the estimating of the degree of relevance between the avatar and the content provider on the basis of the avatar information and the content provider information is estimating a degree of interest of the avatar in the content provider by inputting the avatar information and the content provider information to an interest degree estimation model that has performed learning to output a degree of interest when the avatar corresponding to the avatar information views content of the content provider information once the avatar information and the content provider information are input, and estimating the degree of relevance between the avatar and the content provider on the basis of the degree of interest. It is also possible to estimate the degree of relevance between the avatar and the content provider with high accuracy with the above configuration as well.

Also, a plurality of disclosure levels defining disclosure ranges are set in the personal information of the user. The consent reception unit 14 receives a consent from the user for each of the plurality of disclosure levels. According to the above configuration, the user can finely set the disclosure range of the personal information.

Also, the information processing apparatus 9 further includes the right granting unit 16 that grants a right of the user to receive a reward from the content provider to the user in a case where the consent reception unit 14 receives a consent. According to the above configuration, it is possible to promote the user to disclose own personal information to the content provider.

Also, in a case where the consent reception unit 14 receives a consent, the information processing apparatus 9 further includes a right granting unit 16 that grants a right of the user to receive a reward from the content provider to the user in accordance with the disclosure level of consent, which has been received. According to the above configuration, it is possible to widen the disclosure range in which the user discloses own personal information to the content provider.

### Third Example Embodiment

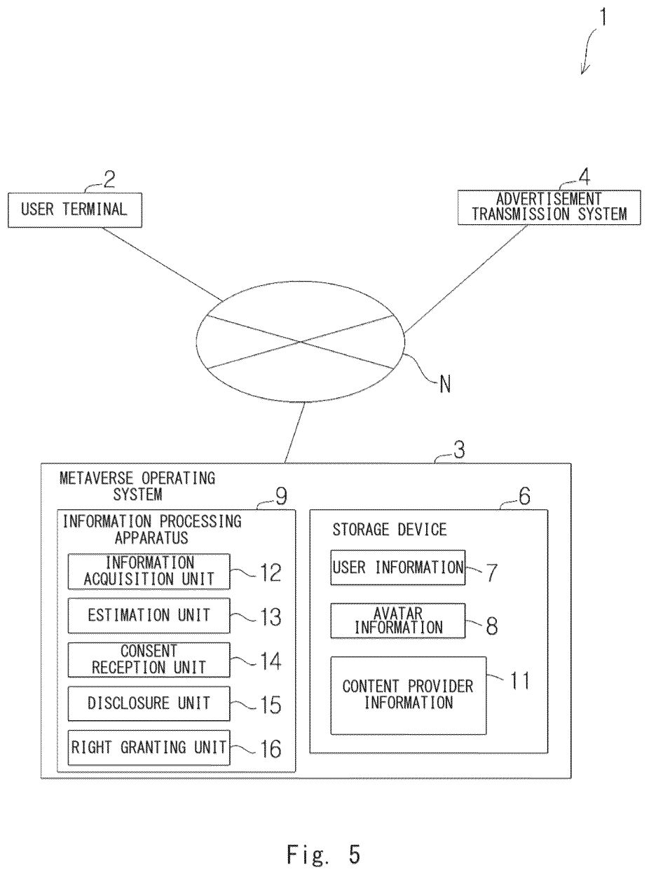

Next, an example of a configuration of an information processing system 1 according to the present disclosure will be described with reference to FIG. 5. Hereinafter, differences between the present example embodiment and the second example embodiment will be mainly described, and repeated description will be omitted.

In the above second example embodiment, the information processing system 1 includes the advertisement distribution system 5, and the advertisement distribution system 5 includes the information processing apparatus 9 and the storage device 10.

On the other hand, the information processing system 1 according to the present example embodiment does not include the advertisement distribution system 5 as illustrated in FIG. 5. A metaverse operating system 3 instead of the advertisement distribution system 5 includes an information processing apparatus 9. Also, a storage device 6 of the metaverse operating system 3 stores content provider information 11 in addition to user information 7 and avatar information 8. In this manner, the information processing system 1 may not include the advertisement distribution system 5 illustrated in FIG. 3.

Although the present disclosure has been described as the configuration of hardware in the aforementioned example embodiments, the present disclosure is not limited thereto. The aforementioned functions (processing) of the information processing apparatus 100, the user terminal 2, the metaverse operating system 3, the advertisement transmission system 4, and the advertisement distribution system 5 may be realized by a computer 1000 with the following configuration, for example.

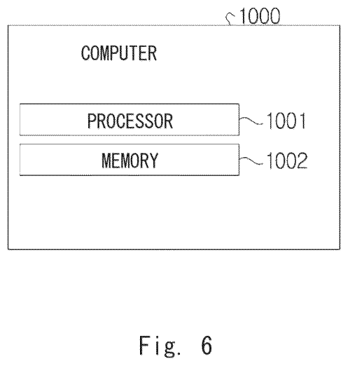

FIG. 6 is a block diagram illustrating a configuration of the computer 1000 that realizes the processing of the information processing apparatus 100, the user terminal 2, the metaverse operating system 3, the advertisement transmission system 4, and the advertisement distribution system 5. As illustrated in FIG. 6, the computer 1000 includes a memory 1002 and a processor 1001.

The memory 1002 is configured of, for example, a combination of a volatile memory and a nonvolatile memory. The memory 1002 is used to store a program to be executed by the processor 1001, data to be used for various kinds of processing, and the like. Storage units of the information processing apparatus 100, the user terminal 2, the metaverse operating system 3, the advertisement transmission system 4, and the advertisement distribution system 5 may be realized by the memory 1002. However, these may be realized by another arbitrary storage device.

The processor 1001 performs processing of each device by reading and executing the program from the memory 1002. The processor 1001 may be, for example, a microprocessor, a micro processor unit (MPU), or a central processing unit (CPU). The processor 1001 may include a plurality of processors.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

The information processing apparatus 9 can also be implemented as an intra-metaverse-space behavior information providing apparatus. The intra-metaverse space behavior information providing apparatus
acquires attribute information of a user who uses a metaverse space,
acquires response information indicating a kind of behavior information (a position, a line of sight, biological information, and the like), collection of which has been allowed by the user in a response, in behavior information of the user in the metaverse space,
acquires demand information (advertisement target information) of an advertiser from the attribute information of the user,
performs matching between the acquired attribute information and the demand information and selects an advertiser with which matching has been successfully made,
presents the selection result to the user and receives selection of the advertiser from the user, and
provides the behavior information of the user to the advertiser on the basis of the response information.

Also, the intra-metaverse-space behavior information providing apparatus acquires reward information (information regarding how much reward can be given back to the personal information) of the selected advertiser,
further presents a reward rate of each advertiser derived from the reward information and the response information of the user to the user, and
receives selection of the advertiser from the user.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Although some or all of the above-described example embodiments may be described as in the following Supplements, the present disclosure is not limited to the following Supplements.

### Supplementary Note 1

An information processing apparatus including:
an information acquisition unit that acquires avatar information indicating attributes of an avatar for each of a plurality of avatars and acquires content provider information indicating attributes of a content provider for each of a plurality of content providers;
an estimation unit that estimates a degree of relevance between the avatar and the content provider on the basis of the avatar information and the content provider information;
a consent reception unit that receives, from a user corresponding to the avatar, a consent to disclose personal information of the user to the content provider with the degree of relevance with the avatar of not less than a threshold value; and
a disclosure unit that discloses the personal information of the user to the content provider in a case where the consent reception unit receives the consent.

### Supplementary Note 2

The information processing apparatus according to Supplementary Note 1, in which the attributes of the avatar include an appearance of the avatar.

### Supplementary Note 3

The information processing apparatus according to Supplementary Note 1, in which the attributes of the avatar include content of utterances or content of chatting of the avatar.

### Supplementary Note 4

The information processing apparatus according to Supplementary Note 1, in which the estimating of the degree of relevance between the avatar and the content provider on the basis of the avatar information and the content provider information is estimating user information indicating attributes of a user corresponding to the avatar information on the basis of the avatar information and estimating the degree of relevance between the avatar and the content provider on the basis of the user information and the content provider information.

### Supplementary Note 5

The information processing apparatus according to Supplementary Note 1, in which the estimating of the degree of relevance between the avatar and the content provider on the basis of the avatar information and the content provider information is estimating a degree of interest of the avatar in the content provider by inputting the avatar information and the content provider information to an interest degree estimation model that has performed learning to output a degree of interest when the avatar corresponding to the avatar information views content of the content provider information once the avatar information and the content provider information are input, and estimating the degree of relevance between the avatar and the content provider on the basis of the degree of interest.

### Supplementary Note 6

The information processing apparatus according to Supplementary Note 1, in which
a plurality of disclosure levels defining disclosure ranges are set in personal information of the user, and
the consent reception unit receives the consent for each of the plurality of disclosure levels from the user.

### Supplementary Note 7

The information processing apparatus according to Supplementary Note 1, further including a right granting unit that grants a right of the user to receive a reward from the content provider to the user in a case where the consent reception unit receives the consent.

### Supplementary Note 8

The information processing apparatus according to Supplementary Note 6, further including a right granting unit that grants a right of the user to receive a reward from the content provider to the user in accordance with a disclosure level of consent, which has been received, in a case where the consent reception unit receives the consent.

### Supplementary Note 9

An information processing method including, by a computer:
acquiring avatar information indicating attributes of an avatar for each of a plurality of avatars and acquiring content provider information indicating attributes of a content provider for each of a plurality of content providers;
estimating a degree of relevance between the avatar and the content provider on the basis of the avatar information and the content provider information;
receiving, from a user corresponding to the avatar, a consent to disclose personal information of the user to the content provider with the degree of relevance with the avatar of not less than a threshold value; and
disclosing the personal information of the user to the content provider in a case where the consent reception unit receives the consent.

### Supplementary Note 10

A program that causes a computer to function as:
an information acquisition unit that acquires avatar information indicating attributes of an avatar for each of a plurality of avatars and acquires content provider information indicating attributes of a content provider for each of a plurality of content providers;
an estimation unit that estimates a degree of relevance between the avatar and the content provider on the basis of the avatar information and the content provider information;
a consent reception unit that receives, from a user corresponding to the avatar, a consent to disclose personal information of the user to the content provider with the degree of relevance with the avatar of not less than a threshold value; and
a disclosure unit that discloses the personal information of the user to the content provider in a case where the consent reception unit receives the consent.

Some or all of the elements (such as configurations and functions, for example) described in Supplementary Notes 2 to 8 depending from Supplementary Note 1 may depend from Supplementary Notes 9 to 10 as well with depending relationships similar to those of Supplementary Notes 2 to 8. Some or all of the elements described in any supplementary notes may be applied to various kinds of hardware, software, recording means for recording software, systems, and methods.

What is claimed is:

1. An information processing apparatus comprising
at least one memory storing computer-executable instructions; and
at least one processor configured to access the at least one memory and execute the computer-executable instructions to:
acquire avatar information indicating attributes of an avatar for each of a plurality of avatars and acquire content provider information indicating attributes of a content provider for each of a plurality of content providers;
estimate a degree of relevance between the avatar and the content provider on the basis of the avatar information and the content provider information;
receive, from a user corresponding to the avatar, a consent to disclose personal information of the user to the content provider with the degree of relevance with the avatar of not less than a threshold value; and
disclose the personal information of the user to the content provider in a case where the consent reception unit receives the consent.

2. The information processing apparatus according to claim 1, wherein the attributes of the avatar include an appearance of the avatar.

3. The information processing apparatus according to claim 1, wherein the attributes of the avatar include content of utterances or content of chatting of the avatar.

4. The information processing apparatus according to claim 1, wherein the estimating of the degree of relevance between the avatar and the content provider on the basis of the avatar information and the content provider information is estimating user information indicating attributes of a user corresponding to the avatar information on the basis of the avatar information and estimating the degree of relevance between the avatar and the content provider on the basis of the user information and the content provider information.

5. The information processing apparatus according to claim 1, wherein the estimating of the degree of relevance between the avatar and the content provider on the basis of the avatar information and the content provider information is estimating a degree of interest of the avatar in the content provider by inputting the avatar information and the content provider information to an interest degree estimation model that has performed learning to output a degree of interest when the avatar corresponding to the avatar information views content of the content provider information once the avatar information and the content provider information are input, and estimating the degree of relevance between the avatar and the content provider on the basis of the degree of interest.

6. The information processing apparatus according to claim 1, wherein a plurality of disclosure levels defining disclosure ranges are set in personal information of the user, and the at least one processor is further configured to execute the instructions to receive the consent for each of the plurality of disclosure levels from the user.

7. The information processing apparatus according to claim 1, wherein the at least one processor is further configured to execute the instructions to grant a right of the user to receive a reward from the content provider to the user in a case where the consent is received.

8. The information processing apparatus according to claim 6, wherein the at least one processor is further configured to execute the instructions to grant a right of the user to receive a reward from the content provider to the user in accordance with a disclosure level of consent which has been received, in a case where the consent is received.

9. A computer-implemented information processing method being performed by at least one processor executing stored instructions to perform steps comprising:
acquiring avatar information indicating attributes of an avatar for each of a plurality of avatars and acquiring content provider information indicating attributes of a content provider for each of a plurality of content providers;
estimating a degree of relevance between the avatar and the content provider on the basis of the avatar information and the content provider information;
receiving, from a user corresponding to the avatar, a consent to disclose personal information of the user to the content provider with the degree of relevance with the avatar of not less than a threshold value; and
disclosing the personal information of the user to the content provider in a case where the consent reception unit receives the consent.

10. A non-transitory computer-readable storage medium storing a program for causing a computer to execute the computer-implemented information processing method according to claim 9.
